(19) United States
(12) Patent Application Publication
(10) Pub. No.: US 2017/0011345 A1
(43) Pub. Date: Jan. 12, 2017

(54) AUTOMATED GOAL ORIENTED MESSAGING USING CHAINS OF MESSAGES

(71) Applicant: Xerox Corporation, Norwalk, CT (US)

(72) Inventors: Atul Singh, Bangalore (IN); Aditya Hegde, Bangalore (IN); Koustuv Dasgupta, Bangalore (IN); Varun Sharma, West Bengal (IN)

(21) Appl. No.: 14/794,432

(22) Filed: Jul. 8, 2015

(51) Int. Cl. G06Q 10/10; H04L 12/58; H04L 29/08

(52) U.S. Cl. CPC G06Q 10/1057; H04L 67/02; H04L 51/04

(57) ABSTRACT

A network computer automatically creates a message plan (based on plan actions and an action order input by an administrator through an administrator website) and executes the message plan based on a user initiating the message plan through a user website. The process of executing the message plan comprises automatically selecting a list of user-specific messages (based on the precondition rules and a user profile of the user using the network computer), automatically providing the user-specific messages to the user through the user website, and automatically monitoring whether the user completes the actions corresponding to the user-specific messages (based on feedback from the user through the user website). The administrator website automatically outputs whether the user completes the actions corresponding to the user-specific messages, and automatically provides a plan revision input that receives changes to the plan actions, the action order, the messages, the precondition rules, and the effect rules.

### BACKGROUND

Systems and methods herein generally relate to automated messaging systems directed toward a goal, and more particularly, to automated goal oriented messaging using chains of messages.

Automated messages can be used to motivate individuals to achieve goals that contribute to their well being, and to enable them to be productive members of an organization. Some goal-oriented messaging systems focus on single, unrelated messages that make it difficult to support and motivate the individual if the individual is unable to achieve progress on a goal.

In one fictitious example, a fictitious user (arbitrarily named Alice) is an employee of a fictitious organization (arbitrarily named Superior Tech Corporation). Superior Tech Corporation is an organization that uses goal-oriented messaging to motivate employees. The organization believes that the health of its employees is critical to the success of its business. The organization uses goal-oriented messaging for early detection and preventive treatment to control diabetes, a chronic disease that can lead to death. Alice is a new employee who has relocated from San Francisco to New York to join the organization. Alice is suffering from diabetes, which is a chronic condition and can lead to death. Both Alice and her new organization would benefit if Alice can keep her diabetes in check. Alice needs to engage in regular medical checkups to monitor her body vitals, and physical exercise to keep her diabetes in check. Being a new employee, Alice needs to enroll in the organization's insurance plan before they can get the medical checkup done. Alice will need help to find a trusted doctor near work or home whom she can comfortably visit. Alice also needs to enroll with the organization's gymnasium facility so that she can engage in physical exercise. A single message or a static chain of messages cannot be used to deliver new messages with appropriate context if Alice is unable to execute afore mentioned activity.

Further, in this example, Superior Tech Corporation acquires a large startup company whose products align well with Superior Tech Corporation's strategic product map. After the merger, employees from the acquired organization are unable to make progress on the control diabetes goal because they are facing difficulty in understanding their insurance entitlements after the merger. Superior Tech Corporation would reap benefits from its investment in goal-oriented messaging if it can proactively track the progress of its employees on the control diabetes goal to identify the lack of adoption in employees formerly belonging to the acquired organization, identify the reasons behind the lack of adoption, and adapt the chain of messages to convey the required information on insurance entitlements to the new employees that are not able to make progress on the goal.

### SUMMARY

Exemplary methods herein provide plan inputs on an administrator website. The plan inputs include action inputs that receive plan actions and an action order, message inputs that receive messages associated with the actions, precondition rule inputs that receive precondition rules defining when the plan actions are applied, and effect rule inputs that receive effect rules defining changes to be made when the plan actions are completed.

Such methods automatically create message plans based on the plan actions and the action order (e.g., in the form of a directed acyclic graph in which nodes are the plan actions and edges define a partial ordering of the plan actions) using a network computer that is in communication with the administrator website. Each of the message plans corresponds to a goal. These methods can display the message plans on the administrator website and provide inputs for accepting or changing the message plan on the administrator website.

Also, such methods automatically identify potential goals for a user based on the user's profile (using the network computer) and automatically display the potential goals on a user website that is in communication with the network computer. The user initiates a message plan by selecting one of the potential goals displayed on the user website, and in response such methods automatically execute the selected message plan.

When executing the selected message plan, the methods perform the following actions. The methods automatically select a list of user-specific messages from the messages that are associated with the actions. The user-specific messages are selected based on the precondition rules and the user's profile. The user-specific messages instruct the user to perform certain ones of the plan actions in the action order.

Additionally, when executing the selected message plan, the methods automatically provide the user-specific messages to the user through the user website, and automatically monitor whether the user completes the actions corresponding to the user-specific messages, based on feedback from the user through the user website. The user-specific messages only include messages that are determined to be applicable to the user (based on application of the precondition rules to the user profile) and the user-specific messages comprise a to-do list for the user to accomplish. Also, when monitoring the user's progress, these methods can determine whether the user completes the actions within specific time limits.

Further, when executing the selected message plan, the methods automatically output, on the administrator website, whether the user has completed the actions corresponding to the user-specific messages based on the monitoring process, and automatically provide, on the administrator website, a plan revision input. The plan revision input receives changes to the plan actions, the action order, the messages, the precondition rules, and the effect rules; and these methods automatically revise the selected message plan based on such changes.

Various systems herein include, among other components, an administrator website that provides a plan input, at least one network computer in communication with the administrator website, and a user website in communication with the network computer. The plan inputs include action inputs that receive plan actions and an action order, message inputs that receive messages associated with the actions, precondition rule inputs that receive precondition rules defining when the plan actions are applied, and effect rule inputs that receive effect rules defining changes to be made when the plan actions are completed.

The network computer automatically creates a message plan based on the plan actions and the action order. The network computer automatically executes the message plan based on a user initiating the message plan through the user website. The process of executing the message plan comprises automatically selecting a list of user-specific messages from the messages (based on the precondition rules and a user profile of the user), automatically providing the user-specific messages to the user through the user website, and automatically monitoring whether the user completes the actions corresponding to the user-specific messages (based on feedback from the user through the user website). The user-specific messages instruct the user to perform ones of the plan actions in the action order. The administrator web site automatically outputs whether the user completes the actions corresponding to the user-specific messages (based on the monitoring process). The administrator website also automatically provides a plan revision input that receives changes to the plan actions, the action order, the messages, the precondition rules, and the effect rules. The network computer automatically revises the message plan based on such changes.

These and other features are described in, or are apparent from, the following detailed description.

### BRIEF DESCRIPTION OF THE DRAWINGS

Various exemplary systems and methods are described in detail below, with reference to the attached drawing figures, in which:

FIG. 1 is a flow diagram of processes performed by various systems and methods herein;

FIG. 2 are tables used by systems and methods herein;

FIGS. 3A and 3B are schematic diagram of directed acyclic graphs produced by systems and methods herein;

FIG. 4 is a schematic diagram of a website produced by various systems and methods herein;

FIGS. 5A-5C are schematic diagrams of websites produced by various systems and methods herein;

FIG. 6 is a schematic diagram of a website produced by various systems and methods herein;

FIG. 7 is a schematic diagram of a website produced by various systems and methods herein;

FIGS. 8A and 8B are schematic diagrams of web sites produced by various systems and methods herein;

FIG. 9 is a schematic diagram of a website produced by various systems and methods herein;

FIG. 10 is a schematic diagram of a website produced by various systems and methods herein;

FIG. 11 is a schematic diagram a directed acyclic graph produced by systems and methods herein;

FIG. 12 is a schematic diagram of a website produced by various systems and methods herein;

FIG. 13 is a schematic diagram of a website produced by various systems and methods herein;

FIG. 14 is a schematic diagram of a system utilized by various systems and methods herein;

FIG. 15 is a schematic diagram of a system utilized by various systems and methods herein;

FIG. 16 is a schematic diagram of a system utilized by various systems and methods herein;

FIG. 17 is a schematic diagram of a system utilized by various systems and methods herein;

FIGS. 18A and 18B are schematic diagrams of a pseudo-code utilized by various systems and methods herein;

FIG. 19 is a schematic diagram illustrating systems herein; and

FIG. 20 is a schematic diagram illustrating devices herein.

### DETAILED DESCRIPTION

As noted above, it can be difficult to support and motivate an individual if the individual is unable to achieve progress on a goal. Each individual is different and, therefore, the systems and methods herein provide a chain of messages that are constructed appropriately to cater to an individual's profile, interests, and progress on a goal. The systems and methods herein provide the ability to track the progress of users on the chain of messages, diagnose the reasons behind lack of progress on goals and modify the chain of messages to address the concerns behind the lack of progress. The systems and methods herein provide an integrated mechanism for tracking the interest and progress of an individual, and the systems and methods herein introduce new messages to help the individual achieve the goal.

As noted in the example above, a new employee (Alice) needs to enroll in the organization's insurance plan, get a medical checkup done, find a trusted doctor near work or home, enroll with the organization's gymnasium facility, etc., in order to address the goal to handle her diabetes condition. A single message is not sufficient to convey the wider context, or provide personalized support required to perform such complex activities. With the systems and methods herein, new messages with appropriate context can be conveyed to the user (Alice, in this example) if they delay or face problems in executing such activity. Therefore, the systems and methods herein address the problem of generation and consumption of a chain of goal-oriented messages that are customized based on an employee's profile and support requirements, and are adapted based on the interest and progress of the employees on the goal. Furthermore, the systems and methods herein address the challenge of providing an end-to-end solution that can be used to track an employee's progress on goals, analyzing and identifying the causes behind the lack of progress on goals, and adapting the message chain to address the concerns identified by the analysis.

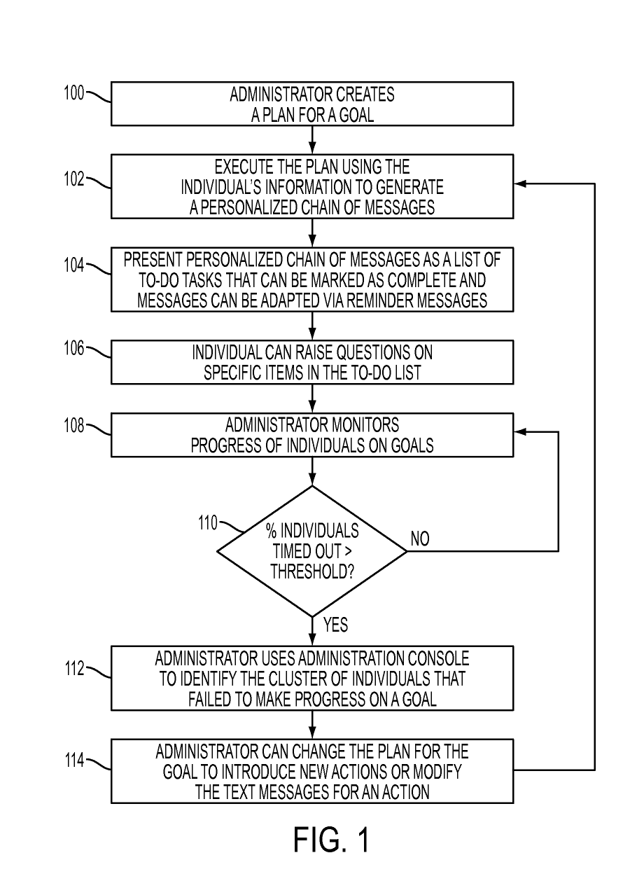

As an overview, the flowchart in FIG. 1 touches on some aspects of the systems and methods herein. The flowchart begins at item 100, where an administrator creates a plan for a goal. In item 102, the systems and methods execute the plan, using an individual's profile information to generate a personalized chain of messages. Subsequently, in item 104, the collaboration platform herein presents the personalized chain of messages to the individual as a list of to-do tasks that can be marked as complete, and such messages can be adapted via reminder messages. Optionally, as shown in item 106, the individual can raise questions on specific items in the to-do list.

Next, as shown in item 108, the administrator monitors the progress of the individuals on their goals. Decision box 110 provides an evaluation as to whether a specific percentage of the individuals that have not accomplished their tasks within the time allotted (e.g., the individuals have “timed out”) is greater than a threshold percentage value. If not, processing returns to item 108 where the administrator continues the monitoring process. If so, processing proceeds to item 112, where the administrator uses the administration console to identify the cluster of individuals that failed to make progress on a goal. Thus, as shown in item 114, the administrator can change the plan for the goal to introduce new actions or modify the text messages for an action, and processing return to item 102 to create a new chain of messages based on the changed plan. These processes are explained in greater detail through the examples and scenarios presented below.

Therefore, as shown above, the systems and methods herein provide a customized and personalized adaptive chain of messages to achieve a specific goal. The systems and methods herein use an administration console and a collaboration platform, and capture the goal as an artificial intelligence planning problem in item 100. Thus, in item 100, a domain expert can use the administration console to create a plan to achieve a goal. The plan is used by the system to create the customized and personalized adaptive chain of messages in item 102.

The administration console presents an overview of the progress of different individuals on the plan to achieve the specific goal in item 108. Thus, in item 114, the administration console can be used to identify the bottleneck messages in achieving the goal. The administration console provides a decision support system that can be used by the domain expert to diagnose the cause of the bottleneck and modify the chain of messages so that employees can be motivated to achieve the goal.

Along with the administration console, the systems and methods herein provide a collaboration platform that presents to the individuals the customized and personalized adaptive chain of messages to achieve a goal as a to-do list in item 104. An individual can mark a message as completed after executing the activities suggested by it. The individual can use the collaboration platform to record their experience and ask for support from the community on a message from her personalize list.

Further, rather than providing a static list of items that are to be accomplished by the user, the systems and methods herein dynamically change the messages that are provided to user based upon the user's feedback, the user's progress, as well as experiences from similar users. Furthermore, a template that is associated with each message is triggered only when a certain condition is met to provide fine-grained support to users and reminder messages that adapt the chain of messages by replacing the original messages with reminder messages. For example, if the user does not accomplish one of the steps of the plan within the allotted time period, a secondary reminder message can be sent, and additional encouragement messages can be sent reminding the user that they have a limited time in which to complete the plan step. Also, such reminder/additional messages can be progressively more detailed than the initial messages, thereby providing more specific and explicit instructions to the user to help them achieve the step in the plan they are having difficulty completing. In addition, such reminder/additional messages can utilize additional support elements from social media, such as providing encouragement messages from similar users who had similar difficulty, but were able to achieve the step that is causing difficulty, and who were ultimately able to accomplish the overall goal.

In Artificial Intelligence (AI), the task of coming up with a sequence of actions that will achieve a goal is called planning. A state-transition system describes all the ways in which a system may evolve, and such can be represented as a directed labeled graph, whose nodes correspond to the states in the system and whose edges represent actions that cause the system to transition from one state to another. In classical planning, a search algorithm is applied on the state-transition graph to obtain a sequence of actions to achieve a goal. Hierarchical Task Network (HTN) planning is another category of planning in which the objective is not to achieve goals, but instead to perform a set of tasks. In HTN planning a domain-expert decomposes the tasks into a set of subtasks that are used as an input to the planner along with a set of primitive operators that can be executed directly.

The systems and methods herein can use an AI or HTN based planner that enables a domain-expert to decompose the goal into a set of actions. Each action is associated with one or more messages that motivate and support the individual to perform the activity and a pre-condition that should be met for the action to be executed (e.g., item 102, above). The planner proposed in this action allows each action to be optionally attached with a plan that is used if a given condition, such as employee not executing the action in a predefined time period, is met. The plan attached with the action replaces the message in the action with additional messages. A domain-expert creates the plan for a goal (that can be presented as a directed acyclic graph in which the nodes are the actions and the edges define a partial ordering of actions). An edge connecting an action A to another action B implies that the action A should be executed before action B. In the plan, one action may be connected to more than one action. Associated with each edge is a progress function that is defined by the domain-expert. The default progress function returns true and is used in case a progress function is not specified. The action on the other end of the edge is executed only if the value of the progress function is true. Each plan starts with a “Start” action and terminates with a “Finish” action. The systems and methods herein use the plan along with the context information for a user to generate a personalized chain of messages that motivate the user to perform actions to achieve the goal (102).

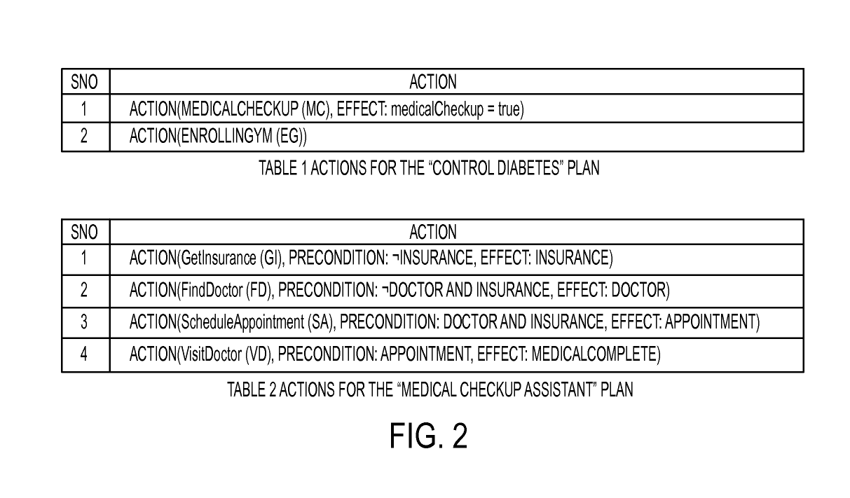

An action or message is specified in terms of preconditions (rules) that must hold before the action can be executed (and before the message is provided); and effects (rules) that ensue when the action is executed are similarly specified. For the diabetes control goal mentioned in the example above, the actions are show in the Table in FIG. 2 and include: 1) get insurance; 2) find doctor; 3) schedule appointment; 4) visit doctor; and 5) enroll in the gym.

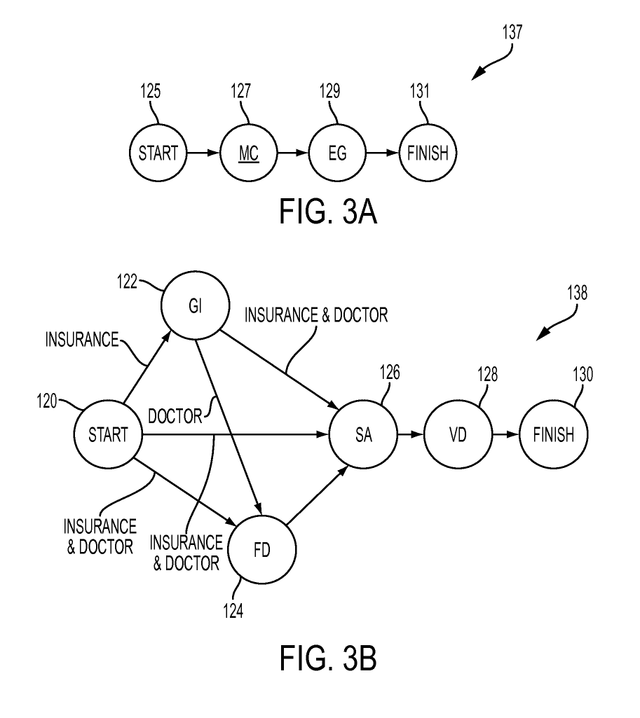

The plan 138 for the diabetes control goal that is generated in item 100 in FIG. 1 is illustrated in FIGS. 3A and 3B. Apart from the default “Start” 125 and “Finish” 131 actions, the plan shown in FIG. 3A includes the actions MC 127 and EG 129 described in Table 2 in FIG. 2. The plan ensures that an employee gets a medical checkup (MC) 127 and enrolls in the gym (EG) 129. The medical checkup assistant plan presented in FIG. 3B can be attached to the MC 127 action and is triggered if the employee is unable to complete the action in a predefined time period. Apart from the default “Start” 120 and “Finish” 130 actions, the plan includes the actions get insurance (GI) 122, find doctor (FD) 124, schedule appointment (SA) 126 and visit doctor (VD) 128 described in Table 2 in FIG. 2. A progress function is associated with every edge and is specified as a logical expression on the edges whenever there are multiple edges branching from an action. The default progress function that returns the value true is used in case the actions lead to only one other action. The plan ensures that an employee gets insurance (GI) 122 and finds a doctor (FD) 124 before executing the actions to schedule an appointment with the doctor (SA) 126 and visit the doctor (VD) 128.

Thus, as shown above, the systems and methods herein create a personalized and adaptive chain of messages that assist the users in achieving a specific goal; provide the ability to monitor the progress of a groups of users as well as individual users in achieving a specific goal; provide a decision support system to diagnose the reasons behind the inability of the users to achieve a goal and modify the chain of messages to address the concerns; and provide fine grained support from the community through the ability to ask and search questions on specific steps. The information is also used by the decision support system.

The following presents three use case scenarios that demonstrate how an administrator and an employee (user) interact with the systems and methods herein. The first use case scenario presents how an administrator can use the systems and methods herein to create a plan for the goal of diabetes control (FIG. 1, 100). The second use case scenario describes how an administrator can use the systems and methods herein to monitor the progress of the organization's employees on the diabetes control goal (FIG. 1, 108) and use the systems and methods herein as a decision-support system to introduce new messages (FIG. 1, 114). The administrator will typically be a domain expert or closely assisted by a domain expert to create and modify a plan. The final use case scenario explains how a user (Alice) can consume a chain of messages using the collaboration platform herein and pursue the diabetes control goal.

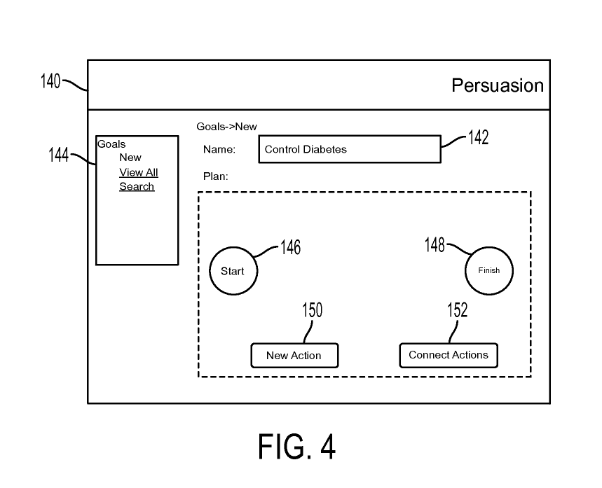

With respect to creating a plan for a goal (100 in FIG. 1) in this use case scenario, an administrator can create a plan for the diabetes control goal described in the Table 1 shown in FIG. 2, and Table 2 in FIG. 2 presents the medical checkup assistant plan which can be attached to the medical checkup action from Table 1 to provide fine grained support, if required. As shown in FIG. 4, the administrator logs into the admin console where they are given the option in a user interface 140 to create a new goal using the Goal->New option from the menu 144 in the left sidebar. Clicking the New link 144 opens the interface to create a new goal 142, as shown in FIG. 4. In the interface 142 provided to create a new goal, they enter a name for the goal, which in this case is “Control Diabetes.” The interface 140 thus provides an editor to create a plan for the goal. The goal for the plan contains the default actions “Start” 146 and “Finish” 148.

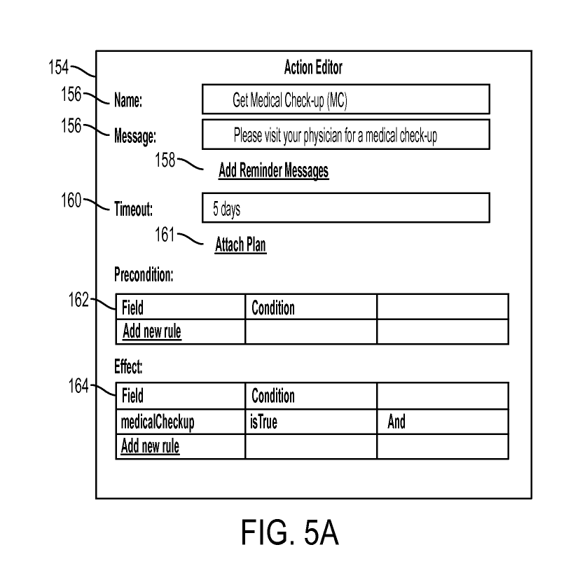

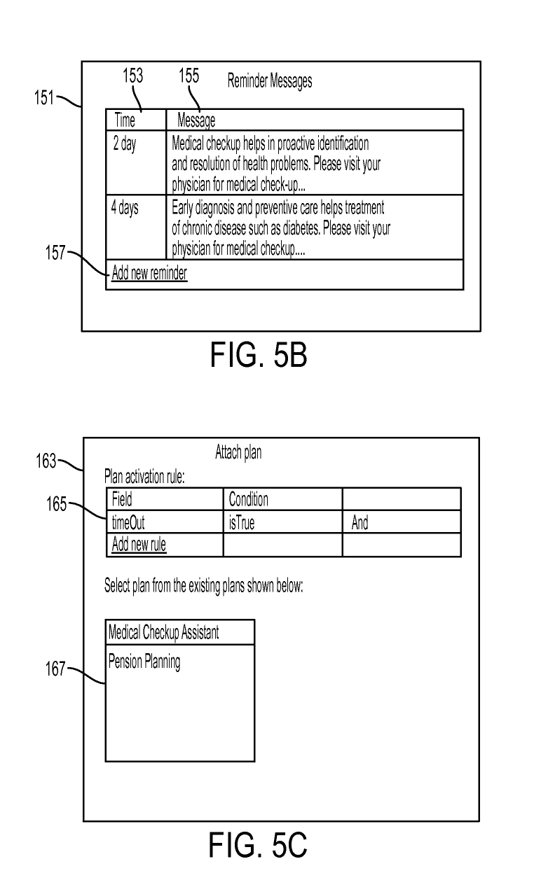

To create a plan, the administrator manually inputs the actions presented in Tables 1 and 2 in FIG. 2. More specifically, the administrator clicks on the “New Action” button 150 in FIG. 4 to open the editor 154, shown in FIG. 5A that can be used to create a new action. The administrator enters a name and a message for the action in input fields 156. The message is used to motivate the employees to perform the action and will be provided to the employees during a specific portion of the plan.

As shown in FIG. 5A, in this example, the administrator enters “Get Medical Check-up (MC)” as the name of the action in input field 156, and “Please visit your physician for a medical check-up” as the message for the action in input field 156. Item 158 provides an option for the administrator to add a reminder messages (and this will be discussed in greater detail below). Input field 160 allows the administrator to enter a “time out” period (e.g., 5 days), which is the duration within which the employee should execute and complete the action 156. Item 161 provides an option for the administrator to attach a plan (and this will be discussed in greater detail below). The administrator enters a precondition in input field 162, and the precondition is a rule that uses the information from employee's profile to determine if this action 154 is applicable for a given employee. In field 162, the administrator can add rules, such as those that state: if the value of a field has a certain condition, then the action 156 should be (or should not be) executed. Since, in this case the action is applicable for all the employees interested in “Control Diabetes” goal rule 162 field is left empty. The administrator can also add the effect of the action in input field 164. The effect field 164 permits the administrator to define rules, such as setting the value of the medical check-up field in the employee's profile to true after the action is executed. The processes shown in FIG. 5A are repeated for all actions, such as the actions shown in the tables in FIG. 2.

As noted above, item 158 provides an option for the administrator to add reminder messages that are displayed to the user instead of the original message (shown in item 156 in FIG. 5A). Specifically, clicking on the “Add Reminder Messages” link 158 in FIG. 5A opens the popup window 151 shown in FIG. 5B. In this window 151, the administrator can add a time 153 and reminder messages 155 that are sent to the employee when the time 153 occurs. If the employee is unable to complete the message in the specified time 153, then the message chain adapts by replacing the original message for the action with the message 155 in the reminder. As shown in FIG. 5B, item 157 allows additional reminders to be added to popup window 151.

As noted above, item 161 provides an option for the administrator to attach a plan. Clicking on the “Attach Plan” link 161 opens the popup window 163 shown in FIG. 5C. In the popup window 163, the administrator can enter a rule that is used to decide if a message generated by the attached plan 163 should be used instead of the original message 156. The administrator can, for example, specify that the attached plan 163 should be used if the value of the time out variable 160 (which signifies that the employee has not been able to execute the action in the time out period) is true, as shown by item 165 in FIG. 5C. Item 167 in FIG. 5C allows the administrator to select from a previously created plan, such as the “Medical Check-up Assistant” and item 167 allows the administrator to attach the “Medical Check-up Assistant” plan to the action MC (item 156 in FIG. 5A).

As noted above, the systems and methods herein dynamically change the messages that are provided to user based upon the user's feedback, the user's progress, as well as experiences from similar users. For example, additional precondition rules can be established so that if the user does not accomplish one of the steps of the plan within the allotted time period, a secondary reminder message will be sent, and additional encouragement messages will be sent reminding the user that they have a limited time in which to complete the plan step. Again, such reminder/additional messages that are established by additional precondition rules can be progressively more detailed than the initial messages, thereby providing more specific and explicit instructions to the user to help them achieve the step in the plan they are having difficulty completing. In addition, such reminder/additional messages established by additional precondition rules can utilize additional support elements from social media, such as providing encouragement messages from similar users who had similar difficulty, but were able to achieve the step that is causing difficulty, and who were ultimately able to accomplish the overall goal.

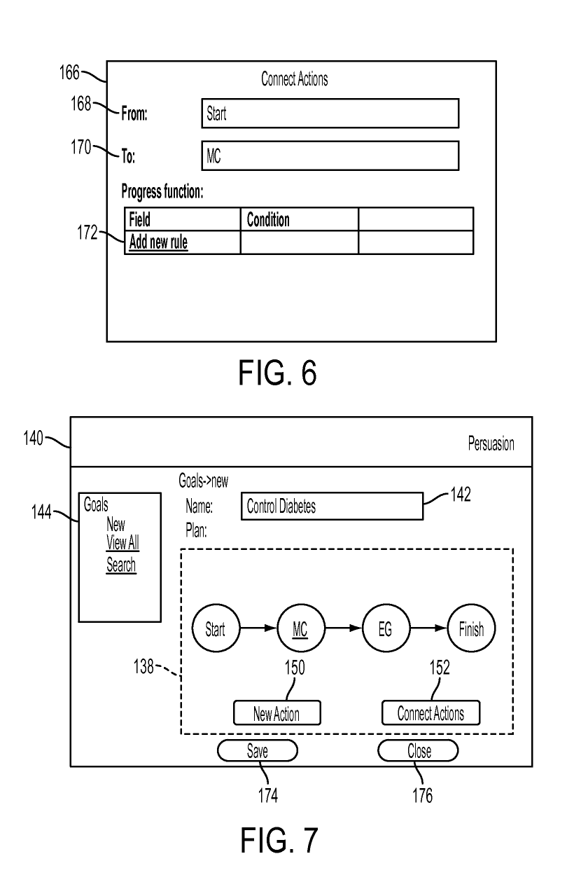

After the administrator has created all the actions using the action editor 154 in FIG. 5, they are returned to interface 140 (FIG. 4), and the administrator can click on the “Connect Action” button 152 to open the editor 166 (shown in FIG. 6) that can be used to order the actions to create a plan.

In the editor 166 the administrator is provided a field 168 to identify an action that should be executed first, and another field 170 to enter a subsequent action, and a field 172 for a progress function. The progress function field 172 allows the administrator to enter one or more rules that are used to decide whether the subsequent action 170 is applicable for an employee. In this example, the administrator enters the action “Start” as the first action field 168 and the action medical check-up (MC) as the subsequent action in field 170. The progress function 172 is entered as rules that are used to decide the subsequent action that should be executed by the employee. Since all the employees executing the “Control Diabetes” plan have to execute the medical check-up action, the progress function is left empty so that the default value of true can be used.

Thus, using the editor 166 shown in FIG. 6, the administrator establishes an order in which the actions (e.g., MC, EG, etc.) shall be performed, to create the plan 138, and such a plan 138 is displayed to the administrator in the interface 140, as shown in FIG. 7. The administrator can edit the plan 138 in FIG. 7 by adding new actions (using button 150) and/or changing the order in which the actions are taken (using button 152). Once the administrator finds the plan 138 to be acceptable, they can save the plan (using save button 174) or close without saving (using close button 176). Similarly, a previously saved plan can be retrieved from memory and edited by recalling the plan (entering the plan name in field 142, or picking the plan from a listing of previously saved plans that will show in item 144 if “view all” is selected) and using the new action 150 and connect action 152 buttons to edit the retrieved plan. Additionally, item 144 allows the user to search for previously saved plans using the “search” option, and such a search will return a smaller list of previously saved plans than will the “view all” option.

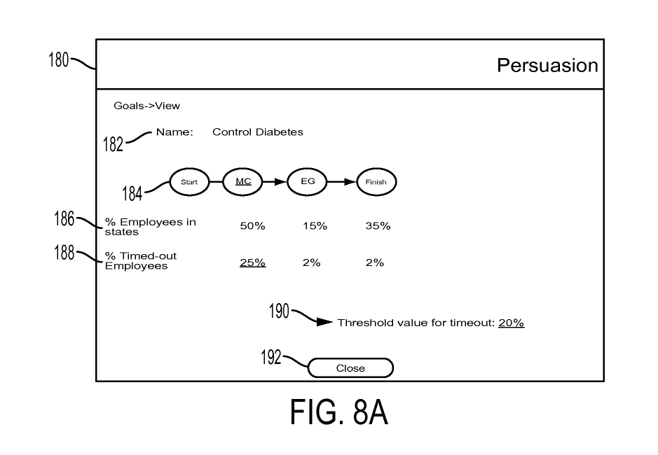

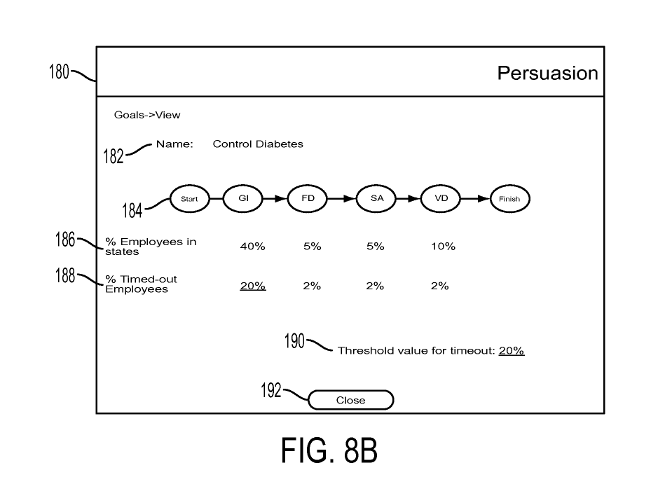

As noted above, an administrator can monitor the progress of individuals on goals (item 108 in FIG. 1). In this example, the administrator can monitor Superior Tech employees on the “Control Diabetes” goal using the administration console 180 shown in FIG. 8. Apart from monitoring the progress of the employees on the different activities (or messages) of the Control Diabetes goal, the administration console also offers the administrator the ability to add new messages (or follow-up messages) and add activities to motivate the employees to achieve the goal.

More specifically, the administration logs into the administration console and goes to the interface 180 shown in FIGS. 8A and 8B that allows them to monitor the progress of the employees on the “Control Diabetes” goal 182. The administration console 180 shows the different actions 184 and the percentage of employees who have not yet completed the action (186). The administration console 180 also shows the percentage of employees following the goal who have timed out on the action (188). As mentioned above, each action has a time out value that is assigned by the plan creator. The time out value represents the expected time within which an employee is should have completed the action. Button 192 allows the administrator to close the interface 180.

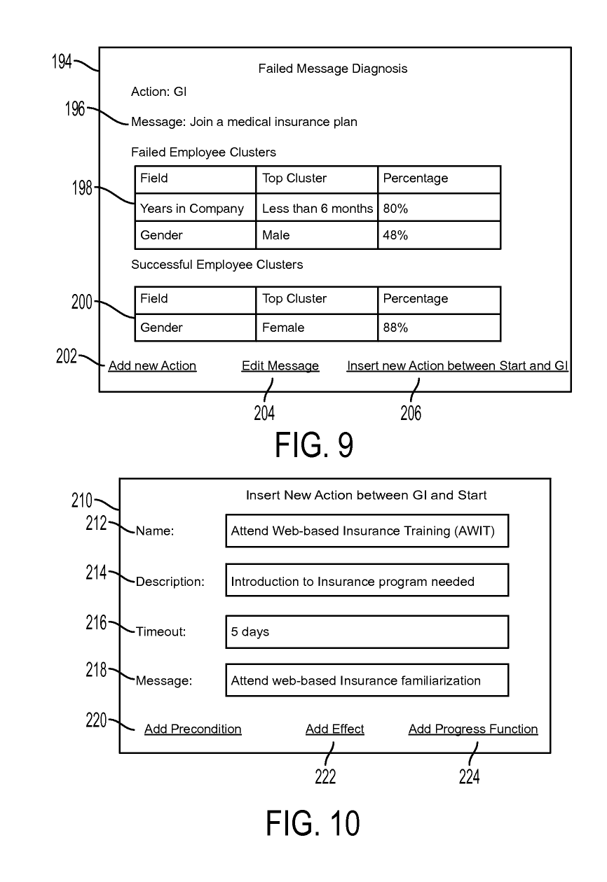

In FIGS. 8A and 8B, each numerical value in “% timed out employees” 188 can be a link for situations in which the percentage of the employees timing out is above a threshold value. Selection of such links in item 188 open a diagnosis window (shown in FIG. 9) that allows the administrator to view the profiles of the employees who have timed out on the action. The default value for the threshold is 20%, and can be change by the administrator by clicking on the link “Threshold value for timeout label” 190 in FIG. 6. In FIG. 8A, 25% of the employees following the goal timed out on the initial action to Get Medical Check-up (MC). The 25% time-out value reaches the threshold value, and so the administrator can click on the link (the 25% in item 188 for MC in FIG. 8A) in the interface 180 to open the diagnosis window in FIG. 9. Similarly, in FIG. 8B, 20% of the employees following the goal timed out on the initial action to Get Insurance (GI). The 20% time-out value reaches the threshold value, and so the administrator can click on the link (the 20% in item 188 for GI in FIG. 8B) in the interface 180 to open the diagnosis window in FIG. 9.

As shown in FIG. 9, any form of useful statistics can be provided. In this example, the interface 194 illustrates the message that was provided 196 and clusters of employees who have timed out. Such clusters can, for example, be on the basis of attributes that include the employee's gender and years in the company (198), age group (200), etc.

In the example shown in FIG. 9, the analysis identifies that 80% of the employees who timed out on the Getting Insurance (GI) action have spent less than 6 months in the company (198). The interface also identifies that while 88% of the females were able to complete the action, only 48% of the males were able to complete the action (198 and 200). The interface allows the administrator to alter the message content (204) or create a new action or follow-up message (202 or 206). When buttons 202 or 206 are selected, the administrator is presented with interfaces 140 and 154 shown in FIGS. 4 and 5 to create a new action or alter the message content.

In this example, on seeing the analysis shown in FIG. 9, that the majority of the employees who timed out are new, the administrator may conduct discussion with a few new employees and identify that the new employees are not able to understand the insurance policies of the company. The administrator may realize that it might be useful for the new employee if they take the web based training to familiarize themselves with the company's insurance policies. Thus, the Failed Message Diagnosis interface 194 in FIG. 9 presents to the administrator analysis that can support the administrator in altering the plan so that the users are motivated to achieve the goal and this interface 194 also displays to the administrator the unresolved questions that were raised by the employees in the collaboration platform described in the subsequent section.

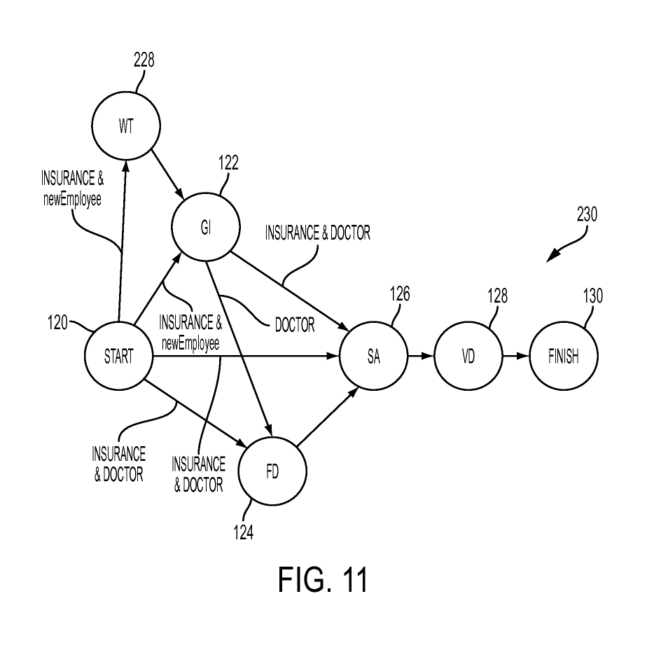

Therefore, the administrator can click on the “Insert new state between Start and GI” link 206 to open the interface 210 shown in FIG. 10 that can be used to add a new action between Start and GI. Thus, in this example, the administrator can add a new action, such as one having a name: Attend Web-based Insurance Training (WT) 212, a description of: Introduction to insurance program needed 214, with time out of 5 days 216, and a message “Attend web-based insurance familiarization” 218 between actions Start and GI. The interface can be used to add a precondition 220 and effect 222 for the action. The action WT is thus inserted between actions Start and GI. The new action WT becomes the subsequent action after Start. The progress function 224 between Start and GI now becomes the progress function between WT and GI. The interface 210 in FIG. 10 can be used to add a new progress function that becomes the progress function between Start and WT and state that employees who do not have insurance and are new should execute the WT action instead of GI. FIG. 11 shows the updated plan to “Control Diabetes.” With the addition of item 228 (WT) the plan is now identified using identification numeral 230.

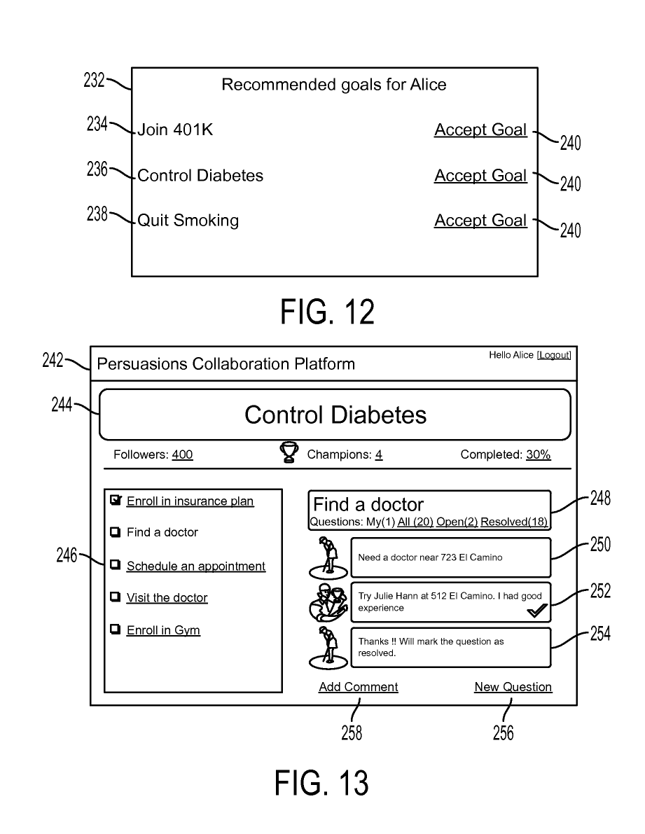

As noted above, an employee consumes (e.g., receives and acts on) a chain of messages to achieve the Control Diabetes goal using the collaboration platform herein. One example of the employee receiving and acting on the plan is shown in FIGS. 12 and 13. Specifically, as shown in the interface 232 in FIG. 12, the user Alice logs into her computer network (e.g., Superior Tech Corporation's Intranet) where Alice is shown goals (join 401K 234, control diabetes 236, quit smoking 238, etc.) that are relevant to her profile in webpage. Along with the messages, there is a link 240 that prompts Alice to accept a goal (see FIG. 12). As noted above, Alice has just relocated to New York and is pleasantly surprised to see the goal “Control Diabetes” because this is an ailment from which Alice suffers. Alice wants to know more about this, and so she accepts the goal by clicking on the “Accept Goal” link 240.

On clicking the “Accept Goal” link 240 Alice starts execution of the plan, and is taken to the collaboration platforms web application page 242 (shown in FIG. 13) for the goal. Alice is added as a follower to the goal and becomes a part of the social community on the message (shown in item 244). The collaboration platforms goal's webpage 242 presents to Alice a personalized list of messages 246 that suggest activities that Alice can execute to achieve the goal. Initially Alice is shown only two messages, “Get Medical Checkup” and “Enroll in Gym.” Alice is unable to “Get Medical Checkup” done and consequently she is shown the messages from the “Medical Checkup Assistant” plan along with the “Enroll in Gym” messages. After Alice enrolls in the insurance plan Alice marks the check box next to the “Enroll Insurance Plan” message in item 246 to mark it as complete (see FIG. 13).

As noted previously, Alice is new to the area and could use help in finding a doctor for the medical check-up. Once Alice clicks on the “Find a doctor” activity link in item 246, Alice is presented with a webpage that can be used to browse the questions on the activity and raise new questions to take community support on the activity. Just below the message “Find a doctor” 248 Alice is presented with links “My,” “All,” “Open,” and “Resolved”. The “All” link presents all the questions on the activity and the “Open” link can be used to see the unresolved questions on the activity. Alice clicks on the “Resolved” link to view the resolved questions on finding a doctor.

Alice browses through the questions and the answers and realizes that no one has raised a query on finding a doctor near her. Therefore, Alice can click on “My” link 248 and on the link “New Question” 256 to open a form where she enters her question that she wants to find a doctor in her area 250 (item 106 in FIG. 1). Alice will subsequently receive an email when another user following the goal answers the question. Alice clicks on the link in the email to view the answer 252. Alice likes the answer and promises the respondent (Jan, who is a champion) that she will mark the question as resolved by clicking on the correct icon next to Jan's answer 254.

In item 244, the web page for the goal 242 shows the number of users following the goal, the champions for the goal and the percentage of followers who have achieved the goal. Alice can click on the link that shows the number of followers to see the users who are following the goal. Champions are users who have achieved the goal and are actively supporting other users. Alice can click on the link that shows the number of champions to view the champion users.

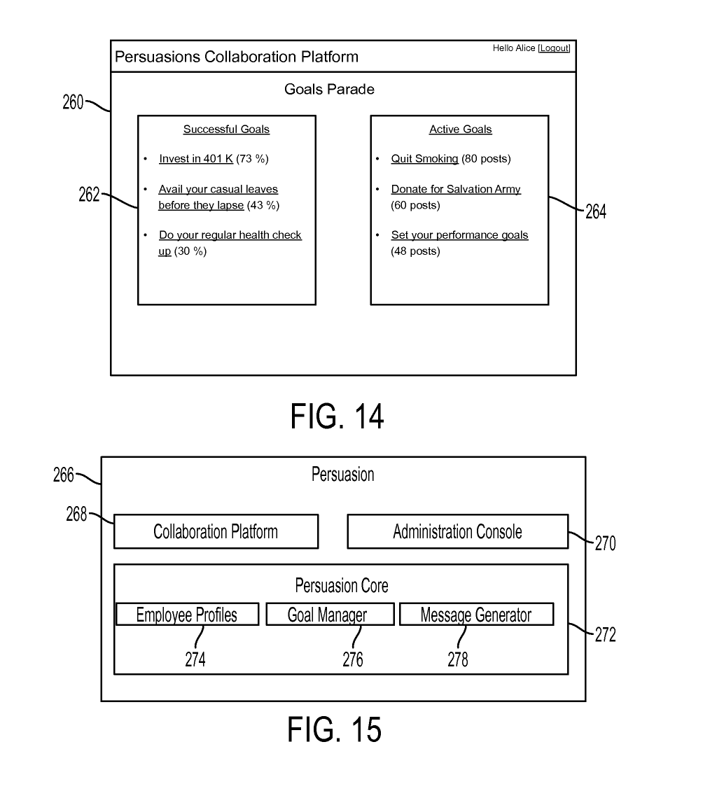

Alice can also see the popular goals in the interface 260, shown in FIG. 14. The interface shows the “Successful Goals” 262 which are the goals with a large percentage of followers who have successfully completed all the goal activities. The interface also shows the “Active Goals” 264 which have the highest total number of questions raised and answered in the last 24 hours. Alice can use this information to follow new goals.

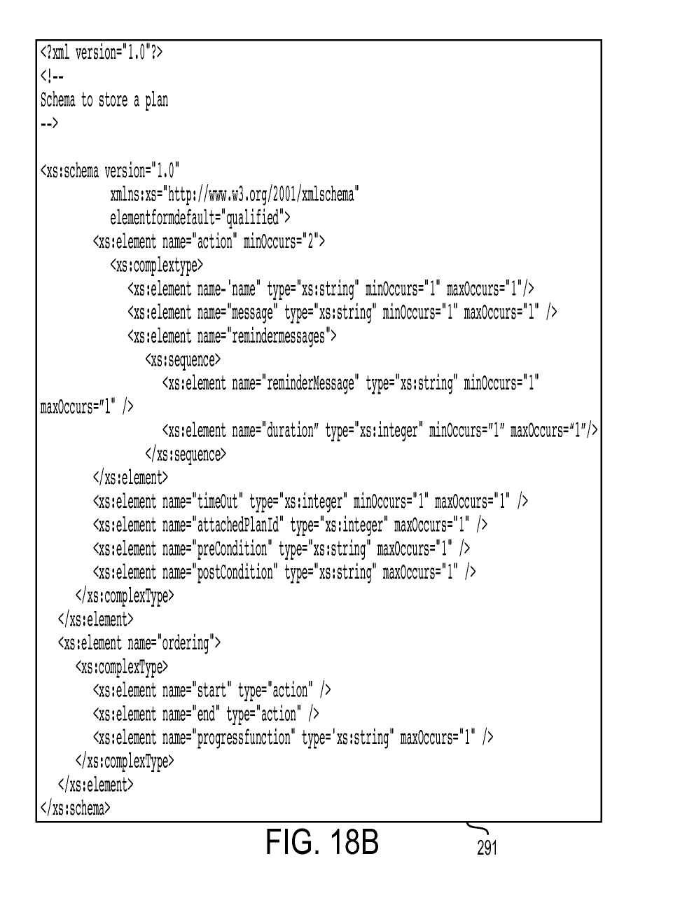

As a system overview, FIG. 15 below presents a conceptual architecture for the systems and methods herein. The architecture includes the following components, and can include others. A persuasion core 272 provides functionality that is used by “collaboration platform” 268 and “administration console” 270 components. The core 272 includes, for example, an employee profile manager 274, a goal manager 276, and a message generator 278. The employee profile manager 274 is responsible for managing the employee personal information, and is also responsible for storing the goals that the employee subscribes to and the employee's progress on the goals. The goal manager 276 is responsible for creating and storing goals, and provides interfaces that can be used by the “administration console” to create a goal. The message generator 278 takes as its input the employee profile and the goal's plan to generate a chain of messages that motivate an employee to achieve a goal. The message generator 278 creates the chain of messages shown in the interface presented in FIG. 13. The process presented in FIG. 18A uses the employee information stored in the “Employee Profile” module, and this is used to generate the chain of messages.

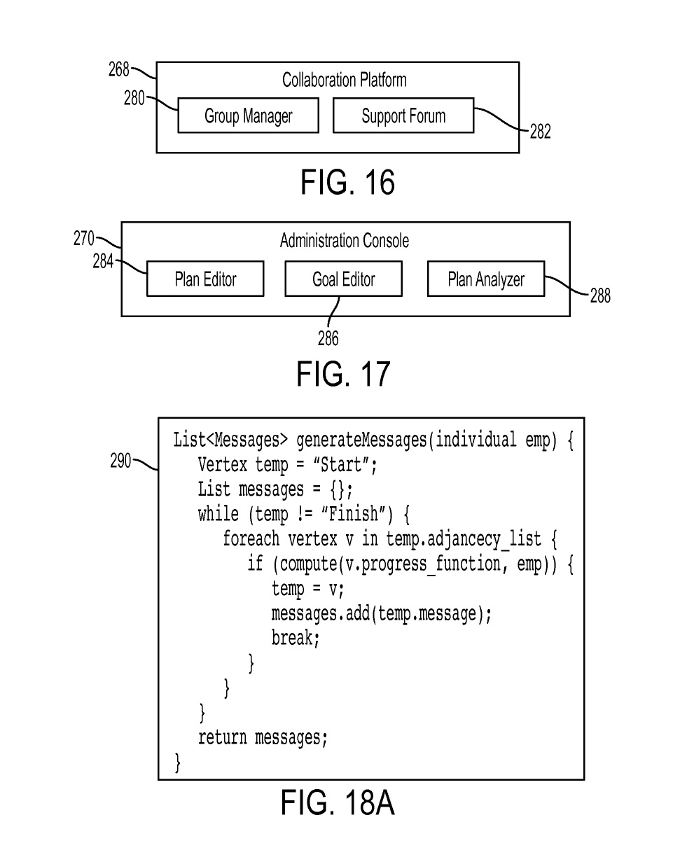

The collaboration platform 268 provides employees an opportunity to consume a chain of messages that motivate the employee to achieve a goal. As shown in FIG. 16, the collaboration platform can include, for example, a group manager 280 that is responsible for creation and management of collaboration groups for a goal. The group manager 280 also generates information such as the number of followers who have successfully achieved the goal. As shown in FIG. 16, the collaboration platform can also include, for example, a support forum 282 that is responsible for allowing employees to ask questions, provide answers and mark answers, as shown in the interface presented in FIG. 13.

The administration console 270 provides a visual interface that can be used by an administrator to create a new goal and a plan and to monitor the progress of different employees on a goal. As shown in FIG. 17, the administration console 270 can include, for example a plan editor 284, a goal editor 286, and a plan analyzer 288. The plan editor 284 provides a visual interface (shown in FIGS. 5A-7) that can be used to create a plan that provides the template for generating a customized and personalized adaptive chain of messages to an employee. The goal editor 286 provides a visual interface that can be used to create a goal, and uses the goal manager module 276 and plan editor 284 from the core 272. The plan analyzer 288 provides visual interfaces (FIGS. 8A-9) that can be used to monitor the progress of employees on the plan for a goal and modify the plan to rectify bottleneck points in the plan. The plan analyzer 288 modules can use, for example, k-means clustering methods using attributes that include the employee's gender, years in the company and age group on the profiles of employee's who successfully complete or time out on an action to generate the clusters shown in FIG. 9. The plan analyzer 288 uses the information from the “Support Forum” modules to determine the unresolved questions raised on an action.

As mentioned above, the plan is a graph in which the nodes are the actions and the edges define the ordering of the actions. Each edge is associated with a progress_function that is used to decide if that edge should be traversed for generating the chain of messages for an employee. FIG. 18A provides an example 290 in Java style pseudo-code for the generate messages process that can be used by the message generator component 278 to generate the chain of messages for an employee. The method takes as an input the details for the employee. The method begins with the “Start” node as the active node and initializes the messages to an empty list. The method iterates over all the edges starting from the active node and computes the value of the progress_function for the employee. When the method finds an edge for which the value of the progress_function is true, then the method adds the message from the node at the other end of the edge to the messages. The methods change the active node to point to the node at the other end of the edge and the method carries on doing this till it reaches the “Finish” action. Once the method reaches the “Finish” action, the method returns the messages.

FIG. 18B similarly presents the XML schema 291 that can be used to capture a plan to generate the adaptive chain of messages. The plan includes the elements: action and ordering. The action element captures the information shown in FIG. 5A-5C and the ordering element captures the information shown in FIG. 6.

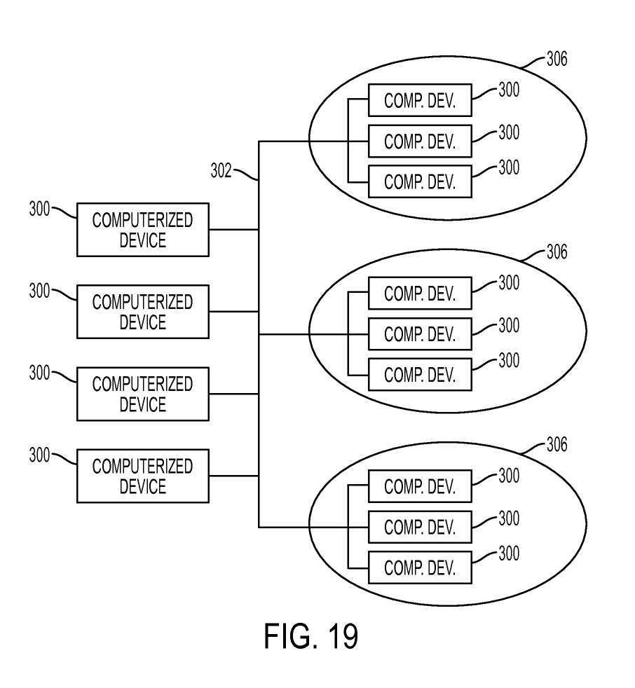

As shown in FIG. 19, exemplary systems and methods herein include various computerized devices 300 located at various different physical locations 306. The computerized devices 300 can include servers, portable devices, personal computers, etc., and are in communication (operatively connected to one another) by way of a local or wide area (wired or wireless) network 302. Some of the devices 300 can be an administrator computer displaying administrator websites, others can be user's computers displaying user websites, and yet others can be networked computers executing the processes described herein.

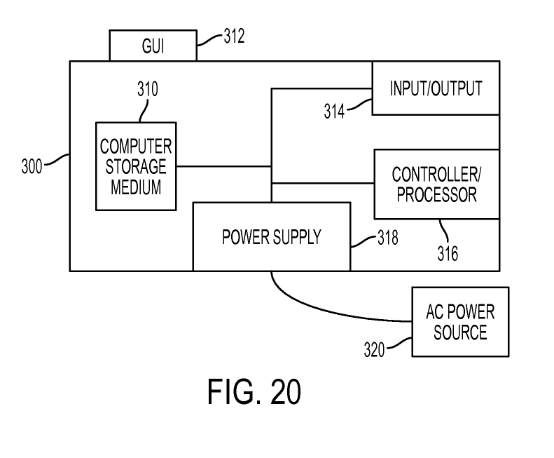

FIG. 20 illustrates one of the exemplary computerized devices 300, which can be used with systems and methods herein and can comprise, for example, a server, a personal computer, a portable computing device, etc. The computerized device 300 can include a controller/tangible processor 316 and a communications port (input/output) 314 operatively connected to the tangible processor 316 and to the computerized network 302 external to the computerized device 300. Also, the computerized device 300 can include at least one accessory functional component, such as a graphical user interface (GUI) assembly 312. The administrator and user may receive messages, instructions, and menu options from, and enter instructions through, the graphical user interface or control panel 312.

The input/output device 314 is used for communications to and from the computerized device 300 and comprises a wired device or wireless device (of any form, whether currently known or developed in the future). The tangible processor 316 controls the various actions of the computerized device. A non-transitory, tangible, computer storage medium device 310 (which can be optical, magnetic, capacitor based, etc., and is different from a transitory signal) is readable by the tangible processor 316 and stores instructions that the tangible processor 316 executes to allow the computerized device to perform its various functions, such as those described herein. Thus, as shown in FIG. 20, a body housing has one or more functional components that operate on power supplied from an alternating current (AC) source 320 by the power supply 318. The power supply 318 can comprise a common power conversion unit, power storage element (e.g., a battery, etc), etc.

Therefore, as shown above, the various exemplary systems and methods herein provide plan inputs on an administrator website (FIG. 4). The plan inputs include action inputs that receive plan actions (FIG. 5) and an action order (FIG. 6), message inputs 158 that receive messages associated with the actions, precondition rule inputs 162 that receive precondition rules defining when the plan actions are applied, and effect rule inputs 164 that receive effect rules defining changes to be made when the plan actions are completed.

Such systems and methods automatically create message plans (FIG. 3) based on the plan actions and the action order (e.g., in the form of a directed acyclic graph in which nodes are the plan actions and edges define a partial ordering of the plan actions) using a network computer 300 that is in communication with the administrator website 300. Each of the message plans corresponds to a goal. These systems and methods can display the message plans on the administrator website and provide inputs for accepting or changing of the message plan on the administrator website (FIG. 7).

Also, such systems and methods automatically identify potential goals for a user based on the user's profile (using the network computer) and automatically display the potential goals on a user website (FIG. 12) that is in communication with the network computer 300. The user initiates a message plan by selecting one of the potential goals displayed on the user website (FIG. 12), and in response such systems and methods automatically execute the selected message plan.

When executing the selected message plan, the systems and methods perform the following actions. The systems and methods automatically select a list of user-specific messages from the messages that are associated with the actions (102, FIG. 1). The user-specific messages are selected based on the precondition rules and the user's profile. The user-specific messages instruct the user to perform certain ones of the plan actions in the action order.

Additionally, when executing the selected message plan, the systems and methods automatically provide the user-specific messages to the user through the user website (246, FIG. 13), and automatically monitor whether the user completes the actions corresponding to the user-specific messages (FIG. 8), based on feedback from the user through the user website (FIG. 13). The user-specific messages only include messages that are determined to be applicable to the user (based on application of the precondition rules to the user profile) and the user-specific messages comprise a to-do list for the user to accomplish (FIG. 13). Also, when monitoring the user's progress, these systems and methods can determine whether the user completes the actions within specific time limits (160, FIG. 5).

Further, when executing the selected message plan, the systems and methods automatically output, on the administrator website (FIG. 8) whether the user has completed the actions corresponding to the user-specific messages based on the monitoring process, and automatically provide, on the administrator website, a plan revision input (FIG. 10). The plan revision input receives changes to the plan actions, the action order, the messages, the precondition rules, and the effect rules; and these systems and methods automatically revise the selected message plan based on such changes (FIG. 11).

The hardware described herein plays a significant part in permitting the foregoing method to be performed, rather than function solely as a mechanism for permitting a solution to be achieved more quickly, (i.e., through the utilization of a computer for performing calculations). As would be understood by one ordinarily skilled in the art, the processes described herein cannot be performed by human alone (or one operating with a pen and a pad of paper) and instead such processes can only be performed by a machine. Specifically, processes such as providing websites, electronic transmission of data over networks, etc., requires the utilization of different specialized machines. Therefore, for example, the websites provided by the systems and methods herein cannot be performed by a human without a machine, and a machine is therefore integral with the processes performed by methods herein. Further, such machine-only processes are not mere “post-solution activity” because the user and administrator interaction through the websites and the messages and monitoring provided through such websites are integral steps of the processes herein that cannot be accomplished without the use of machines. Similarly, the electronic transmissions of each website interaction utilize special-purpose equipment (telecommunications equipment, routers, switches, etc. within item 302) that are distinct from a general-purpose processor. Also, the data transmission is integral with the process performed by the methods herein, and is not mere post-solution activity, because the website-based communications cannot be performed without such electronic transmission. In other words, these various machines are integral with the methods herein because the methods cannot be performed without machines.

Additionally, the methods herein solve many highly complex technological problems outside the technological area of general purpose computers. For example, as mentioned above, conventional systems suffers from the technological problem of not being able to support and motivate an individual if the individual is unable to achieve progress on a goal. Methods herein solve this technological problem by providing an integrated mechanism for tracking the interest and progress of an individual, and the systems and methods herein introduce new messages to help the individual achieve the goal, thereby solving a substantial technological problem that providers experience today.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, Applicant does not intend for the claims presented below to be limited by the attached drawings, but instead the attached drawings are merely provided to illustrate a few ways in which the claimed features can be implemented.

Many computerized devices are discussed above. Computerized devices that include chip-based central processing units (CPU's), input/output devices (including graphic user interfaces (GUI), memories, comparators, tangible processors, etc.) are well-known and readily available devices produced by manufacturers such as Dell Computers, Round Rock Tex., USA and Apple Computer Co., Cupertino Calif., USA. Such computerized devices commonly include input/output devices, power supplies, tangible processors, electronic storage memories, wiring, etc., the details of which are omitted herefrom to allow the reader to focus on the salient aspects of the systems and methods described herein. In addition, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

What is claimed is:

1. A method comprising:
providing plan inputs on an administrator website, said plan inputs comprising:
action inputs receiving plan actions and an action order;
message inputs receiving messages associated with said actions;
precondition rule inputs receiving precondition rules defining when said plan actions are applied; and
effect rule inputs receiving effect rules defining changes to be made when said plan actions are completed;
automatically creating a message plan based on said plan actions and said action order using a network computer in communication with said administrator website;
automatically executing said message plan based on a user initiating said message plan through a user website in communication with said network computer, said executing said message plan comprising:
automatically selecting a list of user-specific messages from said messages based on said precondition rules and a user profile of said user, using said network computer, said user-specific messages instructing said user to perform ones of said plan actions in said action order;
automatically providing said user-specific messages to said user through said user website; and
automatically monitoring whether said user completes said actions corresponding to said user-specific messages based on feedback from said user through said user website;
automatically outputting, on said administrator website, whether said user completes said actions corresponding to said user-specific messages based on said monitoring;
automatically providing, on said administrator website, a plan revision input receiving changes to said plan actions, said action order, said messages, said precondition rules, and said effect rules; and
automatically revising said message plan based on said changes using said network computer.

2. The method according to claim 1, said monitoring comprising determining whether said user completes said actions within specific time limits.

3. The method according to claim 1, said creating said message plan comprising creating a directed acyclic graph in which nodes are said plan actions and edges define a partial ordering of said plan actions.

4. The method according to claim 1, further comprising displaying said message plan on said administrator website and providing inputs for acceptance of said message plan and changes to said message plan on said administrator website.

5. The method according to claim 1, said user-specific messages only including ones of said messages that are determined applicable to said user based on application of said precondition rules to said user profile.

6. The method according to claim 1, said user-specific messages comprising a to-do list for said user to accomplish.

7. The method according to claim 1, further comprising providing an option on said user website for initiation of said message plan.

8. A method comprising:
providing plan inputs on an administrator website, said plan inputs comprising:
action inputs receiving plan actions and an action order;
message inputs receiving messages associated with said actions;
precondition rule inputs receiving precondition rules defining when said plan actions are applied; and
effect rule inputs receiving effect rules defining changes to be made when said plan actions are completed;
automatically creating message plans based on said plan actions and said action order using a network computer in communication with said administrator website, each of said message plans corresponding to a goal;
automatically identifying potential goals for a user based on a user profile using said network computer;
automatically displaying said potential goals on a user website in communication with said network computer;
automatically executing a selected message plan based on a user initiating said selected message plan by selecting one of said potential goals displayed on said user website, said executing said selected message plan comprising:
automatically selecting a list of user-specific messages from said messages based on said precondition rules and a user profile of said user, using said network computer, said user-specific messages instructing said user to perform ones of said plan actions in said action order;
automatically providing said user-specific messages to said user through said user website; and
automatically monitoring whether said user completes said actions corresponding to said user-specific messages based on feedback from said user through said user website;
automatically outputting, on said administrator website, whether said user completes said actions corresponding to said user-specific messages based on said monitoring;
automatically providing, on said administrator website, a plan revision input receiving changes to said plan actions, said action order, said messages, said precondition rules, and said effect rules; and
automatically revising said selected message plan based on said changes using said network computer.

9. The method according to claim 8, said monitoring comprising determining whether said user completes said actions within specific time limits.

10. The method according to claim 8, said creating said selected message plan comprising creating a directed acyclic graph in which nodes are said plan actions and edges define a partial ordering of said plan actions.

11. The method according to claim 8, further comprising displaying said message plans on said administrator website and providing inputs for acceptance of said message plans and changes to said message plans on said administrator website.

12. The method according to claim 8, said user-specific messages only including ones of said messages that are determined applicable to said user based on application of said precondition rules to said user profile.

13. The method according to claim 8, said user-specific messages comprising a to-do list for said user to accomplish.

14. The method according to claim 8, further comprising providing an option on said user website for initiation of said selected message plan.

15. A system comprising:
an administrator website providing plan inputs, said plan inputs comprising:
action inputs receiving plan actions and an action order;
message inputs receiving messages associated with said actions;
precondition rule inputs receiving precondition rules defining when said plan actions are applied; and
effect rule inputs receiving effect rules defining changes to be made when said plan actions are completed;
a network computer in communication with said administrator website automatically creating a message plan based on said plan actions and said action order; and
a user website in communication with said network computer,
said network computer automatically executing said message plan based on a user initiating said message plan through said user website, said executing said message plan comprising:
automatically selecting a list of user-specific messages from said messages based on said precondition rules and a user profile of said user, said user-specific messages instructing said user to perform ones of said plan actions in said action order;
automatically providing said user-specific messages to said user through said user website; and
automatically monitoring whether said user completes said actions corresponding to said user-specific messages based on feedback from said user through said user website,
said administrator website automatically outputting whether said user completes said actions corresponding to said user-specific messages based on said monitoring,
said administrator website automatically providing a plan revision input receiving changes to said plan actions, said action order, said messages, said precondition rules, and said effect rules, and
said network computer automatically revising said message plan based on said changes.

16. The system according to claim 15, said monitoring comprising determining whether said user completes said actions within specific time limits.

17. The system according to claim 15, said creating said message plan comprising creating a directed acyclic graph in which nodes are said plan actions and edges define a partial ordering of said plan actions.

18. The system according to claim 15, said administrator website displaying said message plan and providing inputs for acceptance of said message plan and changes to said message plan.

19. The system according to claim 15, said user-specific messages only including ones of said messages that are determined applicable to said user based on application of said precondition rules to said user profile.

20. The system according to claim 15, said user-specific messages comprising a to-do list for said user to accomplish.
